(19) United States
(12) Patent Application Publication
(10) Pub. No.: US 2022/0004671 A1
(43) Pub. Date: Jan. 6, 2022

(54) Method and Arrangement for Creating a Digital Building Model

(71) Applicant: Siemens Schweiz AG, Zürich (CH)

(72) Inventor: Oliver Zechlin, Zug (CH)

(73) Assignee: Siemens Schweiz AG, Zürich (CH)

(21) Appl. No.: 17/432,576

(22) PCT Filed: Feb. 7, 2020
(86) PCT No.: PCT/EP2020/053057

§ 371 Date: Aug. 20, 2021

(30) Foreign Application Priority Data
Feb. 20, 2019 (DE) 10 2019 202 304.5

(51) Int. Cl. G06F 30/13; G06F 30/12

(52) U.S. Cl. CPC G06F 30/13; G06F 30/12

(57) ABSTRACT

The disclosure relates to a method and an arrangement for creating a digital building model for an existing building, wherein location points in the building are specified by referencing official anchor points outside the building for a reference floor of the building; wherein machine-readable markers are installed in the reference floor at the specified location points; wherein the markers in the reference floor are read in by way of a correspondingly configured mobile reading device (scanning device), wherein, on the basis of the location position of the read-in markers, the geometry of the reference floor is compensated for drift; wherein a digital volume model is created for the rooms in the reference floor in a suitable notation; and wherein the digital volume model of the reference floor is used as reference volume model during the creation of digital volume models for substantially identical floors of the building.

### CROSS-REFERENCE TO RELATED APPLICATIONS

This application is a U.S. National Stage Application of International Application No. PCT/EP2020/053057 filed Feb. 7, 2020, which designates the United States of America, and claims priority to DE Application No. 10 2019 202 304.5 filed Feb. 20, 2019, the contents of which are hereby incorporated by reference in their entirety.

### TECHNICAL FIELD

The present disclosure relates to digital building models. Various embodiments of the teachings herein may include methods and/or arrangements for creating a digital building model for an existing building.

### BACKGROUND

In advance of the creation of a virtual mapping for a building (digital twin) or for a collection of buildings, existing buildings are recorded using scanners, in particular laser scanners. When scanning a building, survey points in the building are recorded and processed by suitable devices. These survey points, however, have to be specified by a surveyor in advance and installed in the building according to the scan.

In this context, the surveyor conventionally uses a tachymeter or a total station to set survey points (anchor points, markers), which are also recorded during the scan procedure. This preparatory procedure requires approximately as much time as the actual scan procedure that follows. This measure means that the location of the building is “northed”, its location is placed by means of coordinates. Furthermore, setting anchor points inside the building compensates the system-related problems of a laser scanner. Over long scan areas (e.g. the walls of large and long rooms), these devices tend to “drift”, i.e. the actual laser point straight line has a curvature. In very large buildings, the earth's curvature even takes effect here.

When using anchor points placed by a surveyor and surveyed in advance, these can be used by software for correction purposes during post-processing (drift compensation). In addition to placing the anchor points, the surveyor passes on the information regarding the respective anchor points or markers (in particular the positions) to the following service providers in the process, who carry out the scanning of the building. Scanning trolleys which can move in the building (e.g. devices from the company NavVis), are able to use laser technology to record the markers installed in the building, read them, and make them available for digital further processing, in particular for use in a digital building information model for the corresponding building.

### SUMMARY

The known approach for determining the survey points in a building and scanning in the survey points for use in a digital building information model, however, is laborious and time-consuming. The teachings of the present disclosure, therefore, provide an efficient method for using scanned-in survey points for a digital building information model. F method for creating a digital building model (BIM) for an existing building (GB), the method comprising: For example, some embodiments include a method for creating a digital map of a building including: specifying location points (OPD1, OPD2) in the building (GB) by referencing (Ref1, Ref2) official anchor points (OAP1-OAP6) outside the building (GB) for a reference floor of the building (GB); installing machine-readable markers (M1-M3) in the reference floor at the specified location points (OPD1, OPD2); reading in the markers (M1-M3) in the reference floor by way of a correspondingly configured mobile reading device (MG1, AV1, MG2, AV2), wherein, on the basis of the location points (OPD1, OPD2) of the read-in markers (M1-M3), the geometry of the reference floor is compensated for drift; and creating an, in particular digital, volume model in the digital building model (BIM) for the rooms in the reference floor in a suitable notation; wherein the digital volume model of the reference floor is used as reference volume model during the creation of digital volume models for substantially identical floors of the building (GB).

In some embodiments, the reference volume model of the reference floor is used during the creation of in particular digital volume models in a digital building model (BIM) for substantially identical floors of a further building.

In some embodiments, the a building information model (BIM) is created or expanded on the basis of the reference volume model of the reference floor.

In some embodiments, the referencing (Ref1, Ref2) of the official anchor points (OAP1-OAP6) in order to specify the location points (OPD1, OPD2) for the markers (M1-M3) takes place by way of a laser tachymeter measurement (LT) or by way of triangulation.

In some embodiments, the machine-readable markers (M1-M3) comprise an optically readable identifier.

In some embodiments, the machine-readable markers (M1-M3) comprise an RFID tag.

As another example, some embodiments include an arrangement for creating a digital building model (BIM) for an existing building (GB), the arrangement comprising: means for specifying location points (OPD1, OPD2) in the building (GB) by referencing (Ref1, Ref2) official anchor points (OAP1-OAP6) outside the building (GB) for a reference floor of the building (GB); means (MG1, AV1, MG2, AV2) for reading in machine-readable markers (M1-M3) installed at the specified location points (OPD1, OPD2) in the reference floor, wherein, on the basis of the location points (OPD1, OPD2) of the read-in markers (M1-M3), the geometry of the reference floor is compensated for drift, and wherein a, in particular digital, volume model can be created in the digital building model (BIM) for the rooms in the reference floor in a suitable notation and can be stored in a storage medium (DB); correspondingly configured processing means (S), in order to use the digital volume model of the reference floor as reference volume model during the creation of digital volume models for floors of the building (GB) or of a further building which are substantially identical to the reference floor.

In some embodiments, the storage medium (DB) is configured such that the reference volume model can be stored as building information model (BIM).

In some embodiments, the storage medium (DB) is configured such that the digital volume models for the floors which are substantially identical to the reference floor can be stored as building information model (BIM).

### BRIEF DESCRIPTION OF THE DRAWINGS

The teachings of the present disclosure and example embodiments of thereof are explained using the example of the following figures, in which:

FIG. 1 shows an exemplary extract of a town plan with exemplary officially surveyed anchor points;

FIG. 2 shows an exemplary arrangement for creating a digital building model for an existing building incorporating teachings of the present disclosure;

FIG. 3 shows an exemplary marker for a specified location point in a building incorporating teachings of the present disclosure;

FIG. 4 shows exemplary model views for an exemplary building incorporating teachings of the present disclosure; and

FIG. 5 shows an exemplary flow diagram for a method for creating a digital building model for an existing building incorporating teachings of the present disclosure.

### DETAILED DESCRIPTION

Various embodiments of the teachings herein include a method for creating a digital building model (e.g. as a “digital twin”) for an existing building, the method comprising:
specifying location points in the building (e.g. markers, anchor points in the building) by way of referencing (in particular by way of optical referencing and corresponding surveying e.g. using a laser tachymeter or a total station) of official anchor points outside the building (e.g. by measuring them in using a tachymeter) for a reference floor of the building;
installing machine-readable markers in the reference floor at the specified location points;
reading in the markers in the reference floor by way of a correspondingly configured mobile reading device (scanning device, e.g. a device from the company NavVis), wherein, on the basis of the location position of the read-in markers, the geometry of the reference floor is compensated for drift; and
creating an, in particular digital, volume model for the rooms in the reference floor in a building information model (BIM) in a suitable notation, wherein the digital volume model of the reference floor is used as reference volume model during the creation of digital volume models for substantially identical floors of the building.

Using the mobile reading device (e.g. scanning device from the company NavVis), only a single floor has to be scanned as reference floor and stored in a digital model. This takes place in a suitable notation, e.g. in IFC notation (Industry Foundation Class). The model of the reference floor may be used to create models for floors with the same or substantially the same design. The floors with the same or substantially the same design do not have to be physically surveyed and scanned in, as the reference model of the reference floor is used for the modeling thereof.

This procedure is also efficient if the reference model of the reference floor cannot always be used one-to-one for a further floor, and manual adjustments by a modeler may be necessary (e.g. by tailoring). In some embodiments, the mobile reading device (scanning device) delivers a curvature-corrected three-dimensional point cloud with photos, sensor information, the earth's magnetic field, access points and text file for the reference floor, advantageously as a volume model for the rooms in the reference floor.

The methods described herein reduce the on-site time requirements; the surveyor, who previously would be engaged throughout the process, only has to survey and set markers in subregions, e.g. outside the building, as well as the non-uniform structures inside the building. The optimization potential of the present methods can be enhanced in particular in uniform buildings or building segments, e.g. often new office buildings. All uniform floors are treated as “non-variable parts”. It is sufficient to survey, mark and scan in one of these uniform floors. After the scan, all floors which build on one another as “duplicates” are identified as “identical” by the processing software, and the corrective measures for the reference floor (which has been surveyed or marked) are transferred to these “identical” floors. If, after the processing by a computing unit/piece of software, a wall has been drawn as straight in the reference floor, then such a “wall line” (viewed from the floor plan) or “wall area” (viewed from the point cloud) is applied to the similar floors.

If a consistent BIM model (building information model, using the objects and the properties thereof) is used, then furthermore the information thereof can also be incorporated (object properties of walls, e.g. prefabricated external wall with the dimensions x y z and optionally further features). If, in addition to the external walls/floor plan, more detailed features are consistently available—such as the elevator region, for example—and if this is identified by software in the scanned data, then this feature can also be incorporated, in order to align similar floors automatically “floor by floor” and to model or integrate them in the building model (BIM). For a floor, in particular for the reference floor, there are discrete datasets in each case (one or more per floor), which are aligned with the other datasets during further processing. This advantageously takes place automatically, advantageously using corresponding plausibility criteria (e.g. elevator doors for an elevator lie in the same vertical axis).

The positions/coordinates of the reference areas (x and y) ascertained by the surveyor can be transferred to the “floor clone” which is built on top thereof. The z axis information could likewise be ascertained and recorded automatically on the basis of further floors, or defined, corrected or refined by BIM object information. Floor heights in the “building sandwich” ordinarily do not differ from one another (lobby and loft often vary).

In some embodiments, the models for the floors are created by a user-friendly “drag and drop” method: It is therefore possible for a building to be built up in the model in a manner similar to Lego bricks. The floor layers can therefore be given information in the model, e.g. by way of an inheritance mechanism, which passes on parameters (e.g. alignment and quality parameters, properties or attributes of the reference floor) to the clone floors based thereon (i.e. the copies of the reference floor).

In some embodiments, the mobile reading device (scanning device) uses software for solving SLAM problems (SLAM: Simultaneous Localization and Mapping). The mobile reading device (scanning device) can therefore act as a mobile robot which, when reading in the measurement points and the associated location coordinates, simultaneously creates a plan for the reference floor. In some embodiments, the plan can be used as part of the building information model (BIM).

In some embodiments, the reference volume model of the reference floor may be used during the creation of digital volume models for substantially identical floors of a further building. In each building, there are uniform building segments. The present teachings make it possible, inter alia, to treat these uniform building segments as identical parts. It is therefore sufficient to survey and mark one of these uniform floors. After the scan, all floors which build on one another as “duplicates” are identified as “identical” by the processing software, and any corrective measures for the reference floor (which has been surveyed or marked) are transferred to these “identical” floors. If, after the processing by a computing unit with corresponding software, a wall has been drawn as straight in the reference floor, then such a “wall line” (viewed from the floor plan) or a “wall area” (when viewed from the point cloud) is applied to the similar floors.

In some embodiments, a BIM model may be created or expanded on the basis of the reference volume model of the reference floor. Building data modeling (building information modeling) is a method for the integrated and therefore optimized planning, creation and operation of buildings. Building data is stored in a virtual digital building model (BIM, Building Information Model) in a machine-readable notation and is maintained, e.g. in a corresponding database, which the parties involved (architect, planner, contractor, building services, facility management, etc.) can access. The digital building model can be created in IFC notation (Industry Foundation Classes), for example.

In some embodiments, the referencing of the official anchor points in order to specify the location points for the markers may be made using a laser tachymeter measurement or triangulation. Using electronic tachymeters (total stations), the measurements can be performed in a very precise and rapid manner. The ascertained data (e.g. in the form of three-dimensional measurement points) may be loaded onto corresponding storage media or directly into corresponding computer programs or data models.

In some embodiments, the machine-readable markers comprising an optically readable identifier (e.g. QR code, barcode). The machine-readable optical identifiers of the markers can be installed at accessible points in the building in a simple manner and can be read by an optical recording unit (e.g. laser scanner; e.g. scanning apparatus from the company NavVis). The recording unit can have corresponding processing means (processor, software), in order to further process the read-in data (measurement points for location data), in order to undertake a drift compensation, for example.

In some embodiments, the machine-readable markers comprise an RFID tag. RFID tags can be installed in a concealed manner, for example. In some embodiments, the recording unit identifies markers present in the building which are characterized or referenced by RFID tags. In some embodiments, there is an arrangement for creating a digital building model (digital twin) for an existing building, the arrangement comprising:
means for specifying location points in the building (markers, anchor points in the building) by referencing official anchor points outside the building (by measuring them in) for a reference floor of the building;
means for reading in machine-readable markers installed at the specified location points in the reference floor, wherein, on the basis of the location position of the read-in markers, the geometry of the reference floor is compensated for drift, and wherein an, in particular digital, volume model can be created for the rooms in the reference floor in a building information model (BIM) in a suitable notation and can be stored in a storage medium; and
correspondingly configured processing means, in order to use the digital volume model of the reference floor as reference volume model during the creation of digital volume models for floors of the building or of a further building which are substantially identical to the reference floor. The means required for implementing the arrangement are usually present during building planning or creation, or it can be simple to access them, e.g. by contracting appropriate specialist companies (e.g. for surveying the anchor points or scanning the markers).

In some embodiments, the storage medium may be configured such that the reference volume model can be stored as a BIM model. This means that the reference volume model can be used for building data modeling directly. Building data modeling (building information modeling) is a method for the integrated and therefore optimized planning, creation and operation of buildings. Building data is stored in a virtual, digital building model (BIM model) in a machine-readable notation and is maintained, e.g. in a corresponding database, which the parties involved (architect, planner, contractor, building services, facility management, etc.) can access. The digital building model can be created in IFC notation (Industry Foundation Classes), for example. There are corresponding computer-aided tools (e.g. CAD tools) for the building data modeling.

In some embodiments, the digital volume models for the floors which are substantially identical to the reference floor being able to be stored as BIM model. In each building, there are uniform building segments. The present invention makes it possible, inter alia, to treat these uniform building segments as identical parts. It is therefore sufficient to survey and mark one of these uniform floors. Storing the floors which are identical to the reference floor in the BIM model enables an efficient creation of the BIM model.

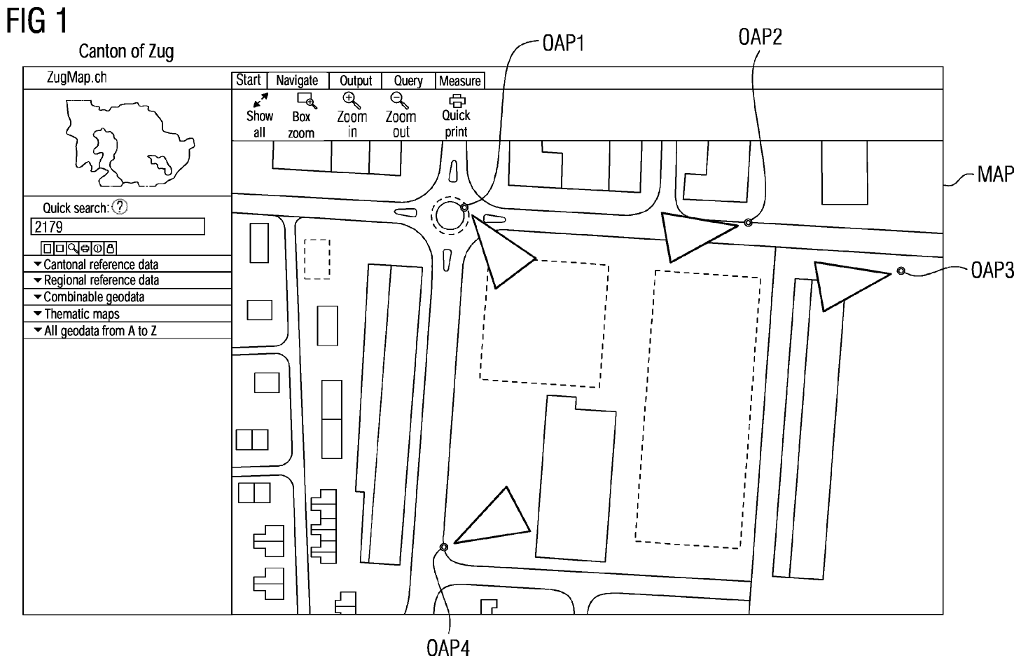

FIG. 1 shows an exemplary extract of a town plan with exemplary officially surveyed anchor points OAP1-OAP4. These anchor points OAP1-OAP4 are determined or used in the specialist field of geodesy, in particular engineering geodesy, e.g. for national surveying, cadastral surveying or building surveying. Anchor points OAP1-OAP4 are also referred to as surveying points or measurement points. They can be specified, for example, by triangulation as trigonometrical points (triangulation stations) with corresponding coordinates. Depending on the application, anchor points are also referred to as elevation datum points, geodetic datum points, elevation marks, position datum points, etc. The anchor points OAP1-OAP4 can be defined, for example, as position coordinates in a Gauss-Krüger coordinate system or in a UTM coordinate system (Universal Transverse Mercator).

By referencing the official anchor points OAP1-OAP4, e.g. by measuring official anchor points OAP1-OAP4 into a building, location points (markers) in the building are specified. These location points (markers) in the building are marked by corresponding identifiers (e.g. QR code). These location points (markers) in the building can be read in by suitable reading apparatuses (e.g. scanning apparatus from the company NavVis), evaluated and stored in a building information model.

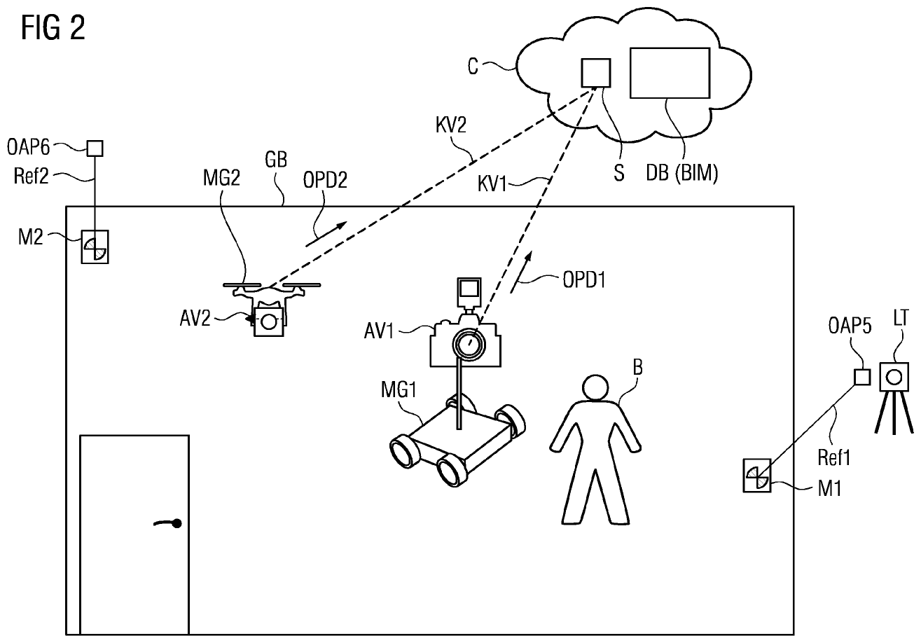

FIG. 2 shows an exemplary arrangement for creating a digital building model (digital twin) BIM for an existing building GB. The arrangement shown comprises:
means LT for specifying location points in the building GB (markers, anchor points in the building) by referencing Ref1, Ref2 official anchor points OAP5, OAP6 outside the building GB (by measuring in) for a reference floor of the building GB;
means MG1, AV1, MG2, AV2 for reading in machine-readable markers M1, M2 installed at the specified location points in the reference floor, wherein, on the basis of the location position of the read-in markers M1, M2, the geometry of the reference floor is compensated for drift, and wherein a digital volume model BIM can be created for the rooms in the reference floor in a suitable notation and can be stored in a storage medium DB; and correspondingly configured processing means S, in order to use the digital volume model BIM of the reference floor as reference volume model during the creation of digital volume models for floors of the building GB or of a further building which are substantially identical to the reference floor.

The model of the reference floor may be used to create models for floors with the same or substantially the same design. The floors with the same or substantially the same design do not have to be physically surveyed and scanned in, as the reference model of the reference floor is used for the modeling thereof. This procedure is also efficient if the reference model of the reference floor cannot always be used one-to-one for a further floor, and manual adjustments by a modeler may be necessary (e.g. by tailoring). Advantageously, the mobile reading device (scanning device, trolley, drone) MG1, MG2 delivers a curvature-corrected three-dimensional point cloud with photos, sensor information, the earth's magnetic field, access points and text file for the reference floor.

In some embodiments, the storage medium DB is configured such that the reference volume model can be stored as BIM model BIM. This takes place in a suitable notation, e.g. in IFC notation (Industry Foundation Class). In some embodiments, the storage medium DB is configured such that the digital volume models for the floors which are substantially identical to the reference floor can be stored as BIM model BIM, e.g. in IFC notation (Industry Foundation Class).

The specifying of location points M1, M2 in the building GB (markers, anchor points in the building) by referencing Ref1, Ref2 official anchor points OAP5, OAP6 takes place, for example, by way of a laser tachymeter LT or by way of triangulation. Using a mobile reading device MG1 (e.g. scanning device from the company NavVis), only a single floor has to be scanned as reference floor and stored in a digital model. The mobile reading device MG1 comprises, for example, an optical recording apparatus AV1 for reading in machine-readable markers M1, M2 installed at the specified location points in the reference floor. In principle, it is also possible to use a drone (unmanned aerial vehicle) MG2 with a corresponding recording apparatus AV2 for reading in machine-readable markers M1, M2 installed at the specified location points. The mobile reading devices MG1, MG2 can move in the building in an independent and autonomous manner, or controlled by an operator B.

As the mobile device MG1, it is possible, for example, to use a trolley with appropriate measurement equipment AV1, which is pushed through the building GB by an operator B, such as the M3 trolley from the company NavVis, for example. As the mobile device for recording the target state, it is also possible to use a mobile robot, for example a traveling robot with appropriate measurement devices, which travels around in the corresponding building in an autonomous or semi-autonomous manner. As the mobile device MG2 for recording the target state, it is also possible to use a drone (unmanned aerial vehicle) with appropriate measurement devices, which moves in the building GB and/or around the building GB in an autonomous manner. The advantage of using a drone MG2 lies inter alia in being very simple to use in staircases or stairwells. A drone can be used autonomously (with corresponding programming and control), semi-autonomously, or manually (i.e. controlled by an operator).

Via suitable communication connections KV1, KV2 (e.g. via corresponding radio connections, WLAN, Internet, mobile radio connection), it is possible for the location point data (location points) OPD1, OPD2 of the markers M1, M2 read by the recording apparatuses AV1, AV2 to be forwarded to a server S. The location point data OPD1, OPD2 of all read-in markers in the building GB can be merged into a point cloud at the server S. The server S (computer with corresponding processing and storage means) analyzes the point cloud and maps this into a building information model BIM, e.g. in the form of a digital volume model.

In some embodiments, a reference volume model of a reference floor may be used during the creation of digital volume models for substantially identical floors of the building. In each building, there are uniform building segments. The present teachings make it possible, inter alia, to treat these uniform building segments as identical parts. It is therefore sufficient to survey and mark one of these uniform floors. The building information model BIM may be stored in a suitable database DB, e.g. in an in-memory database, which enables rapid access. In some embodiments, the server S is implemented in a cloud infrastructure C.

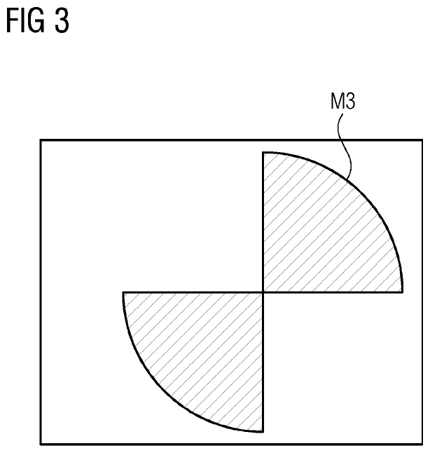

FIG. 3 shows an exemplary marker M3 for a specified location point in a building. In some embodiments, the marker M3 comprises a machine-readable or an optically readable identifier (e.g. QR code, barcode). The machine-readable optical identifiers of the markers can be installed at accessible points in the building in a simple manner and can be read by an optical recording unit (e.g. laser scanner; e.g. scanning apparatus from the company NavVis). The recording unit can have corresponding processing means (processor, software), in order to further process the read-in data (measurement points for location data), in order to undertake a drift compensation, for example.

In some embodiments, the marker M3 is suitable for solving SLAM problems (SLAM: Simultaneous Localization and Mapping). The mobile reading device (scanning device) can therefore act as a mobile robot which, when reading in the measurement points (markers) and the associated location coordinates, simultaneously creates a plan for the corresponding building floor.

In some embodiments, the marker M3 comprises a cross sign for precise locating and an arrow for the orientation (e.g. alignment according to cardinal direction). In some embodiments, the marker M3 comprises a unique identification number (e.g. ID number). In some embodiments, the marker M3 consists of a robust material, which can also be used on an external building wall. In some embodiments, the marker M3 comprises bibliographic data (e.g. point in time of the location referencing, point in time of the installation, responsible company, responsible processor, official anchor point on the basis of which the referencing took place).

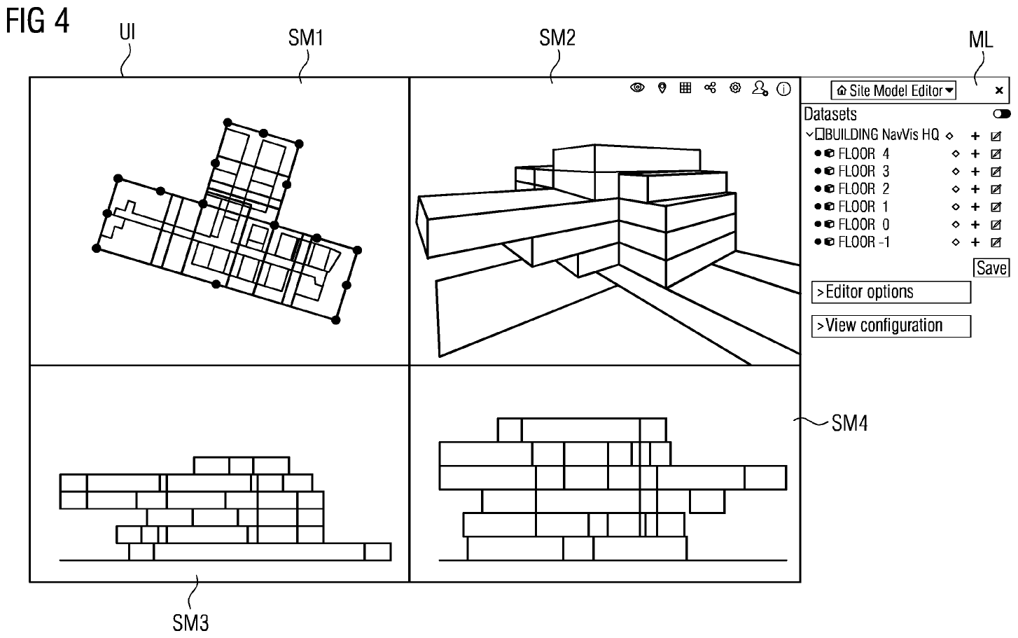

FIG. 4 shows exemplary model views SM1-SM4 for an exemplary building on an exemplary user interface UI. The exemplary user interface UI can be shown on a display (e.g. touch screen) of a computer display, for example. The exemplary model views SM1-SM4 show different views or types of representation of digital volume models as aspects (parts) of a building information model. The views SM1-SM4 show exemplary 2D or 3D views of the building model. The location coordinates of the model are based on the read-in and evaluated markers during the scanning of the building associated with the model. The user interface UI comprises a menu bar ML for user inputs or user selections.

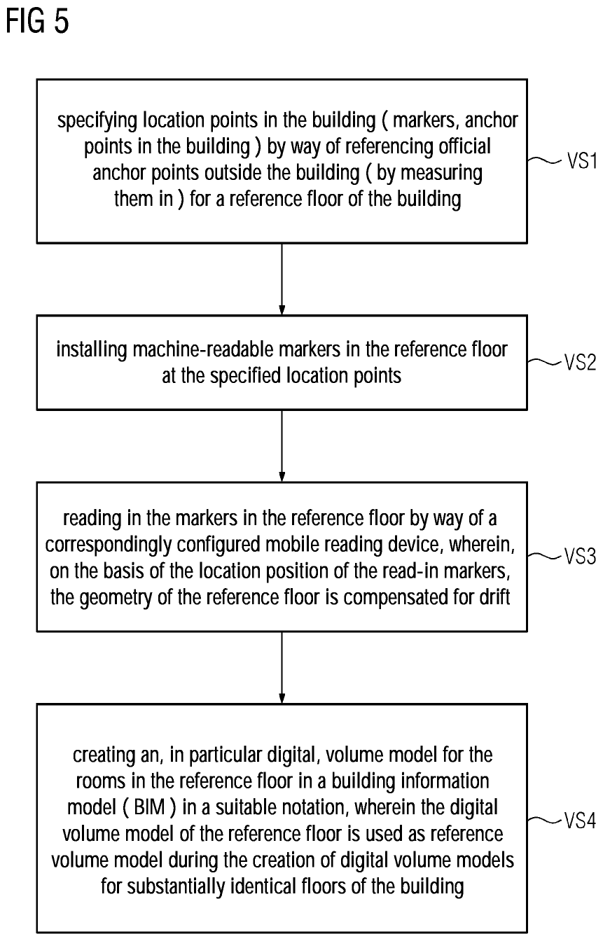

FIG. 5 shows a flow diagram for an example method for creating a digital building model for an existing building. The method comprises:
specifying location points in the building (markers, anchor points in the building) by referencing official anchor points outside the building (by measuring them in) for a reference floor of the building;
installing machine-readable markers in the reference floor at the specified location points;
reading in the markers in the reference floor by way of a correspondingly configured mobile reading device (e.g. scanning device, NavVis device from the company NavVis), wherein, on the basis of the location position of the read-in markers, the geometry of the reference floor is compensated for drift; and
creating an, in particular digital, volume model in the digital building model (BIM) for the rooms in the reference floor in a suitable notation; wherein the digital volume model of the reference floor is used as reference volume model during the creation of digital volume models for substantially identical floors of the building. The specifying of location points (markers, anchor points in the building) in the building by referencing official anchor points takes place, for example, by way of a laser tachymeter or by way of triangulation.

Using a mobile reading device (e.g. scanning device from the company NavVis), only a single floor has to be scanned as reference floor and stored in a digital model. This takes place in a suitable notation, e.g. in IFC notation (Industry Foundation Class). The model of the reference floor is used to create models for floors with the same or substantially the same design. The floors with the same or substantially the same design do not have to be physically surveyed and scanned in, as the reference model of the reference floor is used for the modeling thereof. This procedure is also efficient if the reference model of the reference floor cannot always be used one-to-one for a further floor, and manual adjustments by a modeler may be necessary (e.g. by tailoring). Advantageously, the mobile reading device (scan device) delivers a curvature-corrected three-dimensional point cloud with photos, sensor information, the earth's magnetic field, access points and text file for the reference floor.

Exemplary content of a point cloud file:

ply

format ascii 1.0

element vertex 363

property float x

property float y

property float z

property float scalar scan time from start

property float scalar roll

property float scalar pitch

property float scalar yaw

property uint scalar confidence metric

comment UTC time at start 1528458354.284151

end header

−0.000374 −0.000614 0.000247 10.016065 −0.000821 −0.037225 −0.013847 0

0.001295 0.016669 −0.016714 10.916214 0.000584 −0.048837 −0.016327 26907

−0.000672 0.002347 0.001899 11.816589 −0.000535 −0.039471 −0.015925 50000

−0.001323 0.009148 −0.010352 12.716636 −0.001709 −0.044635 −0.016510 50000

0.001556 0.003548 −0.001648 13.616427 0.000603 −0.036830 0.013826 50000

0.004702 0.013384 −0.008795 14.541398 0.004530 −0.038767 −0.013606 50000

0.001446 0.004157 0.000075 15.466380 0.003677 −0.042195 −0.014400 50000

0.005786 0.004428 −0.008930 16.466257 0.002561 −0.040600 −0.013492 50000

0.003914 0.002555 0.002479 17.466155 0.004913 −0.039357 −0.013419 50000

0.003208 0.002262 −0.003176 18.466278 0.004496 −0.044100 −0.012279 50000

−0.000103 −0.005178 0.004468 19.466257 0.006104 −0.043616 −0.010986 50000

0.003960 −0.004793 −0.007028 20.466523 0.007117 −0.041868 0.002362 50000

A point cloud file can be translated or converted into the notation of a building information model (BIM model) by a corresponding converter. In some embodiments, a BIM model is created or expanded, e.g. into IFC notation, on the basis of the reference volume model of the reference floor.

The methods described herein may be implemented using correspondingly configured hardware and software components (e.g. processor unit, storage means, input/output units, software programs). The methods enable an optimized and efficient conversion or creation of a digital twin. During building creation and during building management, inter alia, this enables improvements regarding costs and time position for inter alia performing and offering sales units.

### REFERENCE CHARACTERS

MAP town plan
OAP1-OAP6 official anchor point
LT laser tachymeter
M1-M3 marker
GB building
C cloud
S server
DB database
BIM building information model
KV1, KV2 communication connection
B operator
MG1, MG2 mobile device
AV1, AV2 recording apparatus
OPD1, OPD2 location point
Ref1, Ref2 referencing
ML menu bar
UI user interface
SM1-SM4 site model

What is claimed is:

1. A method for creating a digital building model for an existing building, the method comprising:
specifying location points in the building by referencing official anchor points outside the building for a reference floor of the building;
installing machine-readable markers in the reference floor at the specified location points;
reading in the markers in the reference floor using a correspondingly configured mobile reading device, wherein, on the basis of the location points of the read-in markers the geometry of the reference floor is compensated for drift;
creating a volume model in the digital building model for the rooms in the reference floor in a suitable notation; and
using the digital volume model of the reference floor as a reference volume model during creation of digital volume models for similar floors of the building.

2. The method as claimed in claim 1, further comprising using the reference volume model of the reference floor during the creation of digital volume models in a digital building model for similar floors of a further building.

3. The method as claimed in claim 1, further comprising creating or building information model using the reference volume model of the reference floor.

4. The method as claimed in claim 1, wherein referencing the official anchor points includes a laser tachymeter measurement or triangulation.

5. The method as claimed in claim 1, wherein the machine-readable markers comprise optically readable identifiers.

6. The method as claimed in claim 1, wherein the machine-readable markers comprise RFID tags.

7. A system for creating a digital building model an existing building the system comprising:
means for specifying location points in the building by referencing official anchor points outside the building for a reference floor of the building;
means for reading in machine-readable markers installed at the specified location points in the reference floor;
wherein, on the basis of the location points of the read-in markers, the geometry of the reference floor is compensated for drift, and wherein a volume model is created in the digital building model for rooms in the reference floor in a suitable notation and to be stored in a storage medium; and
a processor programmed to use the digital volume model of the reference floor as reference volume model during creation of digital volume models for floors of the building or of a further building similar to the reference floor.

8. The system as claimed in claim 7, wherein the storage medium stores the reference volume model as a building information model.

9. The arrangement as claimed in claim 7, wherein the storage medium stores the digital volume models for the floors similar to the reference floor as a building information model.
